(19) United States
(12) Patent Application Publication
(10) Pub. No.: US 2015/0363824 A1
(43) Pub. Date: Dec. 17, 2015

(54) Method and System for Tracking Advertisement Effectiveness

(71) Applicant: Peter Polson, (US)

(72) Inventor: Peter Polson, Seattle, WA (US)

(21) Appl. No.: 14/740,248

(22) Filed: Jun. 15, 2015

Related U.S. Application Data
(60) Provisional application No. 62/012,378, filed on Jun. 15, 2014.

(51) Int. Cl. G06Q 30/02; G06F 17/30

(52) U.S. Cl. CPC G06Q 30/0246; G06F 17/30569; G06F 17/30424

(57) ABSTRACT

A method and system for tracking advertisement effectiveness is provided as a means to increase the efficiency of advertising campaigns. The method and system accomplishes this by combining consumer demographic and purchasing data signals with advertisement exposure data signals to control the allocation of advertising campaign resources.

### CROSS-REFERENCE TO RELATED APPLICATIONS

This application claims priority and benefit under 35 U.S.C. 119 to U.S. patent No. 62/012,378, filed on 15 Jun. 2014, which is incorporated herein by reference in its entirety.

### BACKGROUND

Advertising is ubiquitous in many aspects of life and huge amounts of resources are invested to promote and market brands to consumers through advertising. Due to a dearth of data about actual individualized consumer conversions and advertisement exposure, misjudgments are made about advertisement effectiveness, which leads to a mis-allocation of large portions of the resources and effort.

### BRIEF SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

Embodiments of a system are described that transform receipt record from financial transactions, combined with consumer location records and demographic records, to control an allocation of advertisement resources.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a digital ad campaign control system 100.

FIG. 2 illustrates a method for tracking advertisement effectiveness and controlling advertisement allocation in accordance with one embodiment.

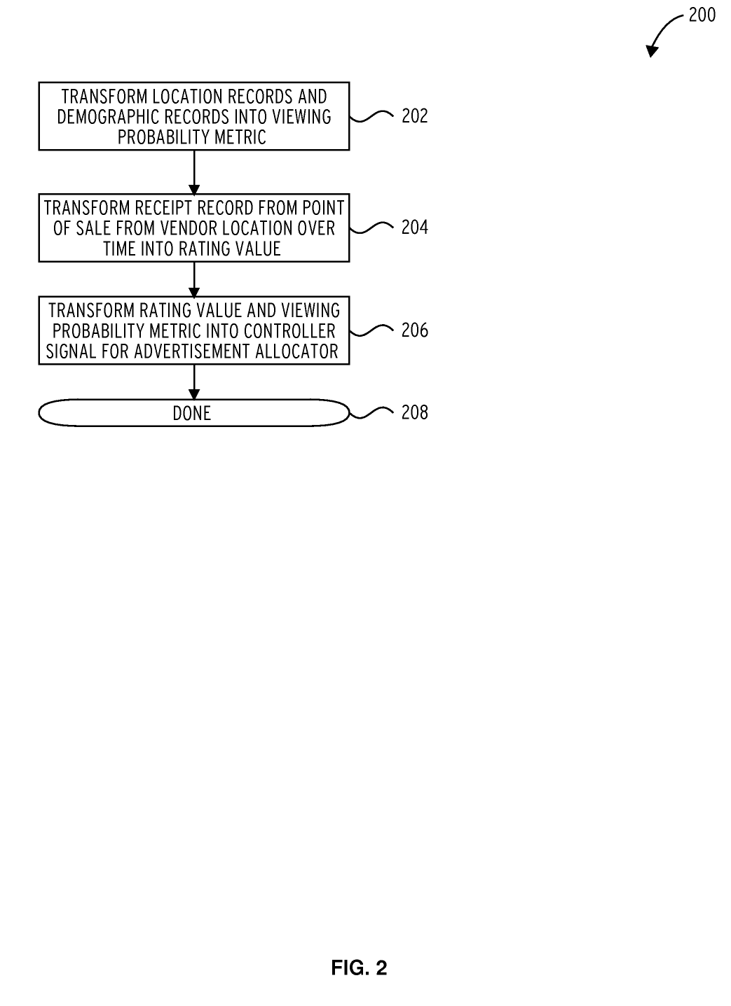

FIG. 3 is a flow chart illustrating an embodiment of an ad exposure probability determination process 300.

FIG. 4 is a figure describing a method for transforming receipt record from point of sale into a rating value

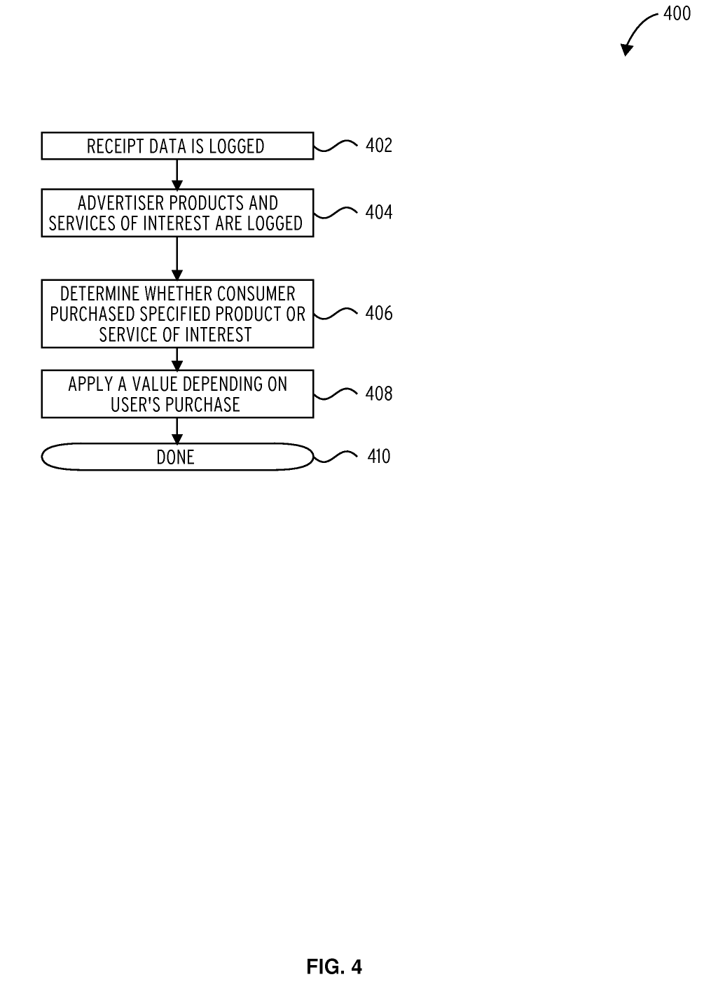

FIG. 5 is a figure describing a method to transform a rating value and viewing probability metric into a controller signal for an advertisement allocator

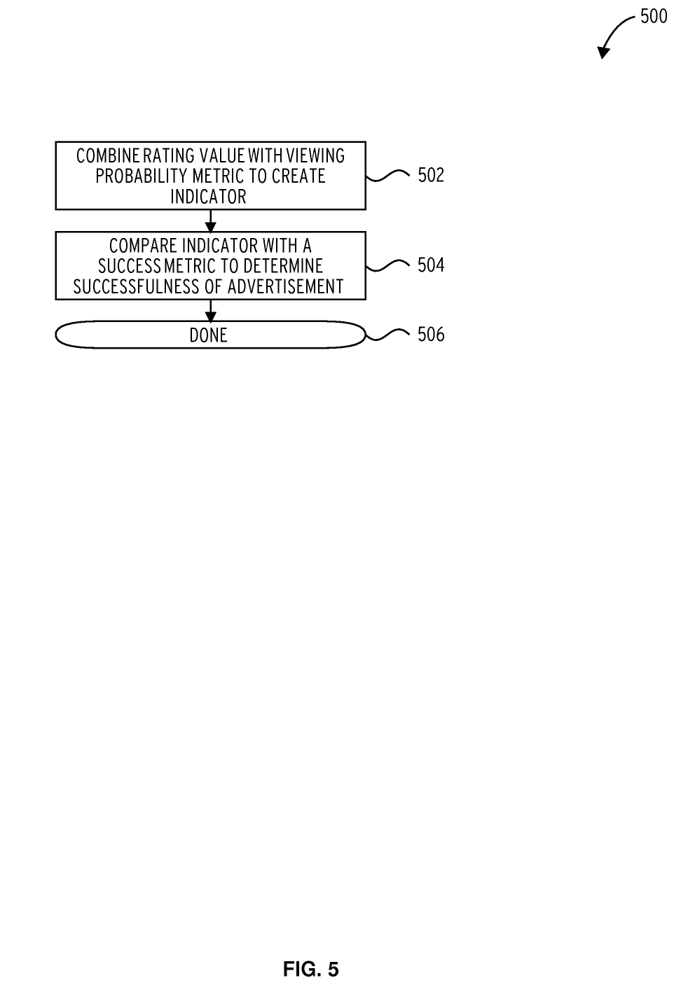

FIG. 6 illustrates a digital apparatus 600 that may implement components and machine processes described herein.

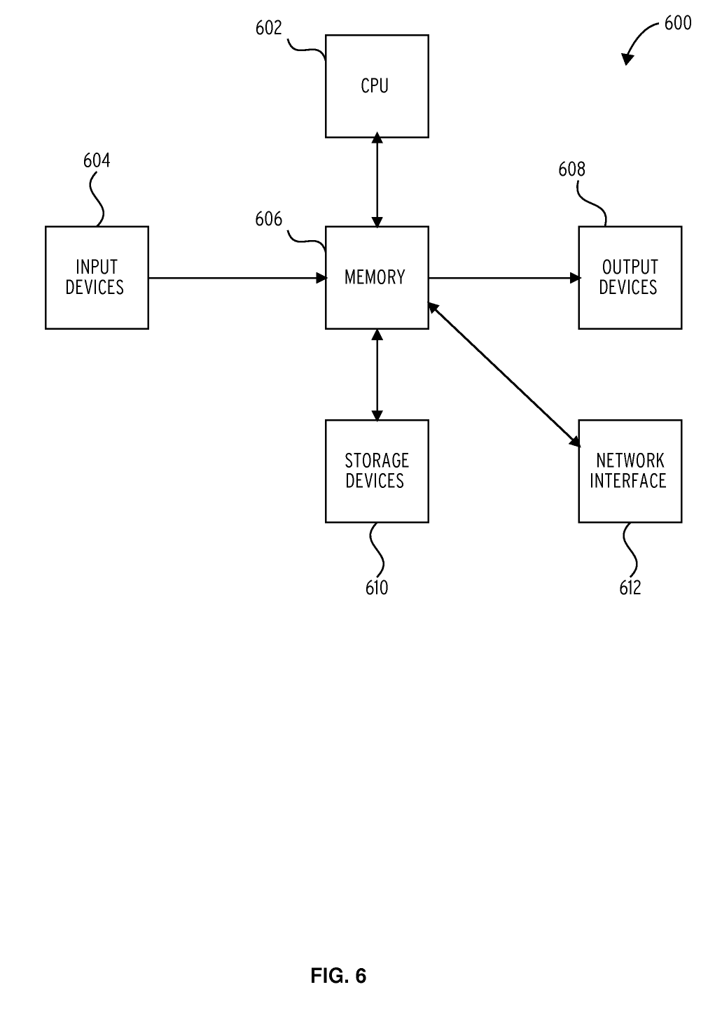

FIG. 7 illustrates a server 700 (e.g., one of the networked machine components described herein) in accordance with one embodiment.

### DETAILED DESCRIPTION

### Glossary

“Advertisment allocator” in this context refers to a machine or other entity the purpose of which is to allocate advertisements between media outlets or channels.

“Demographic records” in this context refers to purchaser's attributes such as age, sex, geographic location, hobbies and subscriptions.

“location records” in this context refers to any collected data (current or historical) regarding the location of a user. In some embodiments this may be data such as GPS data, location metadata, manual check-in.

“point of sale” in this context refers to any purchase, query or other financial transaction, regardless of where or when the transaction occurs. In some embodiments the transaction may occur over the internet, in person or via a third-party intermediary.

“Receipt record” in this context refers to a record from a transaction which in one embodiment may be a list of individual line-items and prices. In some embodiments, the receipt records may be generated before, concurrent to or after the transaction. In some embodiments the receipt record may be a physical receipt, invoice, confirmation email, or be produced through an account query into the user's account after-the-fact, or via a third-party service such as Apple Pay records.

“Transaction record” in this context refers to information surrounding a financial transaction which includes, but is not limited to (including any subset thereof): merchant information (such as merchant name and location), purchase price and date of the transaction, billing address, credit card information.

### DESCRIPTION

Describe herein is a system for measure effectiveness of an advertising campaign in driving consumer behavior. The effectiveness of an advertisement campaign is based on measurement and comparison of consumer purchasing behavior before, during and/or after the advertisement campaign derived from actual purchases made by consumers in categorized groups.

In some embodiments, consumers may opt in to receive notifications from trusted third parties and/or particular merchants through their budgeting applications. In some embodiments, consumers may receive rewards for opting in, including, but not limited to, cash back rewards, rebates, discounts, coupons, reward points, sweepstakes entries, purchase points, and/or advance notice or access to sales. Consumer purchasing data is then reviewed for particular types of transactions, the location, amount, type of purchase and frequency of such purchases.

Purchase data may be captured by any means generally used. In some embodiments, a user may manually enter all or part of purchase information. In another embodiment, a user may scan in or take a picture of a receipt or other transaction document and purchases and amounts are recognized by optical character recognition (OCR). In additional embodiments, users may mail in receipts. Users may also forward emails or invoices to a central email address. In further embodiments, users may allow access to their email accounts to a third party and the third party may search or otherwise identify email receipts. In yet another embodiment, users may allow access to bank or credit card accounts to a third party which may then extract purchases. The third party may identify the names of merchants where purchases were made, the amount spent at each location, the time of purchase and the frequency of visits.

Each item purchased can be grouped with the other items purchased in the same transaction and matched with bank and credit card transactions to ensure that all purchases are being captured. In some embodiments, if a receipt is not sufficiently detailed, algorithms may be used to back out purchases for retailers with smaller inventory by comparing purchase totals with likely combinations of purchases. In other embodiments, if there is no receipt information for a bank or credit card transaction, a user may be asked to provide additional detail regarding the transaction. Receipt record with individual items may be helpful but isn't necessary.

In some circumstances, receipt line items are not utilized. The system operates based on information that more (or fewer) purchases were made at or from a particular vendor when an ad was displayed.

In the example of Coca Cola, line items are helpful to know if a user purchase more Coke among their larger grocery purchases.

If an item is identified from the user data, it may be verified with a bank or credit card, matching the individual purchase with the total purchase made in that transaction and verifying that the sale occurred. The purchasing information from the consumer may be aggregated with other consumers. Such aggregation may be grouped by amount of purchase, frequency of purchase, demographic information for the consumers, location of purchases or any other criteria desired by the merchant.

In some embodiments, merchants or manufacturers may determine if those consumers are current, past or potential buyers of their goods and services based on demographic and/or purchasing information. The merchant or manufacturer may additionally plan advertisement campaigns based on the information assembled. In some embodiments, advertisement campaigns may target consumers who shop at other, similarly situated stores. For example, Lowes may design an advertisement campaign targeting Home Depot customers, or Coca Cola may target Pepsi customers. In other embodiments, merchants may target consumers who have not shopped at that merchant or bought that product recently, though they have in the past. In further embodiments, merchants or product manufacturers may seek to reward their best customers.

The success or failure of an advertisement campaign may be determined based on changes in purchasing behavior on the part of the consumer. Purchasing information may be evaluated for changes in purchasing behavior and/or increases in purchasing from a particular merchant or a particular product during the time of the campaign. If the purchasing rates go up, or if the consumer switches from a competitor, the advertisement campaign may be viewed as a success. If the purchasing rates go down, or stay the same, or the consumer does not switch from a competitor, the advertisement campaign may be modified.

As an example, Hawaiian Airlines may run an advertising campaign in a geographic location. They have billboards, postal mailings, bus advertising, and local print media. To compare spending, we'll look not just at absolute spending on Hawaiian Airlines, but also relative spending versus other airline carriers with routes that overlap with Hawaiian. And if we have receipt records in addition to the high level credit card data, we may specifically compare purchases for Seattle to Maui routes between those two population groups.

In one embodiment, the probability engine computes a probability score for a user that the user has seen an advertisement. The user receives 1 point for visiting a physical merchant in the target zip codes where the billboards are posted based on transaction location records, 1 point if the user's GPS on their phone shows them passing through this neighborhood, or 2 points if the user lives in the target zip. Thus the system will monitor geo-coordinates for a consumer device and associated timing for the consumer device at or near corresponding geo-coordinates. The user receives 2 more points if they have a subscription to a local print medium featuring the advertisement in their expense records (specifically a transaction that shows that they are a paid subscriber to that medium) and/or if their billing address matches the address of a the print medium subscriber. Thus the system correlates a consumer address with print subscriptions. They receive 2 points if their billing address matches addresses that have received postal mailings from the airline. And they receive 3 points if they've been shown a related advertisement via direct advertisement on an associated application. Thus the consumer's interaction with a device application is monitored especially in regard to exposure to digital advertising in the context of the application.

//compute probability score
var zipCode = 2; //set zipcode score
var billBoardGPS =1; //set billboard exposure score
var subscriber = 2; //set subscription score
var applicationAd = 2; //set application advertisment exposure score
var probabilityCutoff = 3; //set probability level to examine
zipCode + billBoardGPS + subscriber + applicationAd = totalScore;

//total probability score for user

In one embodiment, a sample of customers with a probability score of 3 or more compare can be compared to a control sample with zero points. The data may also normalize for the demographics, focusing on households with adults in the 30 to 50 years of age range and determine if spending at Hawaiin Airlines changed more with the 3+ point sample than with the zero point sample.

forEach(selectedUsers in users){ //for every user in selected demographic find probability

score

zipCode + billBoardGPS + subscriber + applicationAd = totalScore; //total probability

score for user

}//repeat for a control group
import hawaiianAirlinesSpending; //import line item spending for user
import hawaiianAirlinesSpendingControl; //import line item spending for control group
//breakpoint
if (totalScore > probabilityCutoff ){ //take users with a total score and examine compared

to control users

priorHawaiianAirlinesSpendingControlPercent − hawaiianAirlinesSpendingControlPercent

= purchaseRateControl; //calculate purchase rate for control group

priorHawaiianAirlinesSpendingPercent − hawaiianAirlinesSpendingPercent =

purchaseRate; //calculate purchase rate

var output = purchaseRate.compareTo(purchaseRateControl);//compare purchase rate to

control rate

return output; //return the customer comparison
}

The output may be that Hawaiian Airlines increased dollar spend in its advertised area with 3+ point users by 15% versus a 5% increase in spend for other airlines (Alaska, United, etc) among the same group of people. This shows a relative gain in marketshare. Furthermore, Hawaiian Airlines dollar spend for zero point users increased 6%. This suggests that Hawaiian Airlines is winning customers faster in the neighborhoods where it has focused its recent advertising campaign. This then confirms the efficacy of the advertising.

### DRAWINGS

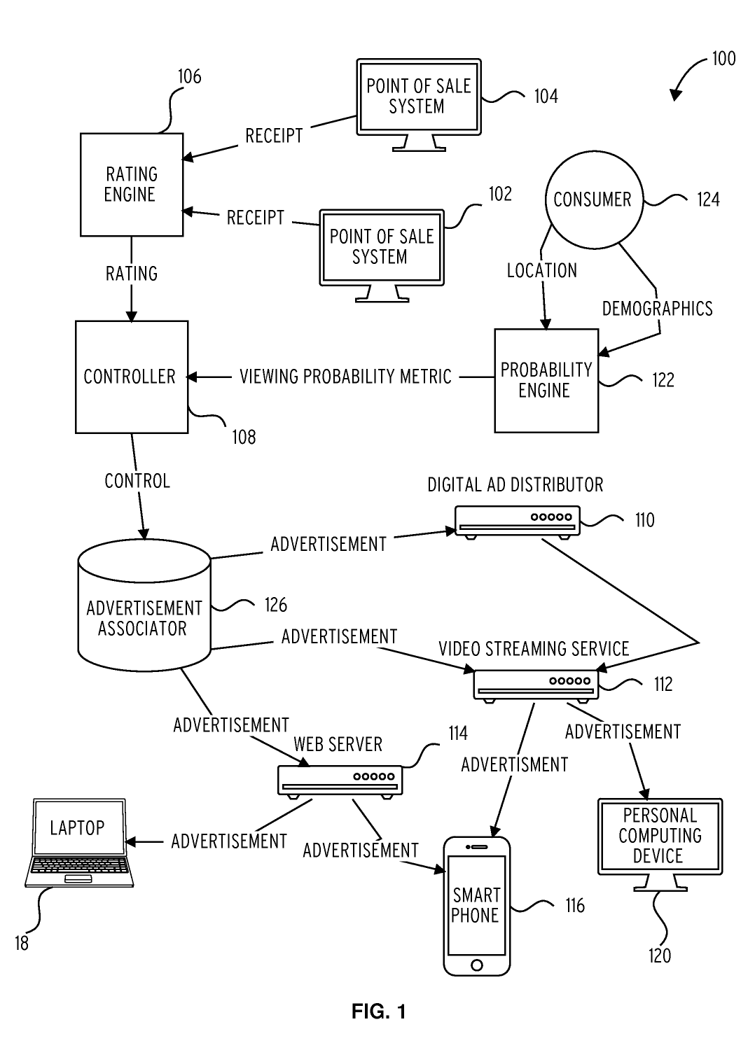

FIG. 1 illustrates an embodiment of a digital ad campaign control system 100. The digital ad campaign control system 100 comprises, inter alia, a rating engine 106, a controller 108, and a probability engine 122.

The rating engine 106 receives a receipt from one or more point of sale system 102 and point of sale system 104, transforms the receipt into a rating and communicates the rating to a controller 108. A probability engine 122 receives a location and demographics from a consumer 124 and transforms the location and demographics into a viewing probability metric that is communicated to the controller 108.

The controller 108 transforms the rating and viewing probability metric into a control signal to an advertisement associator 126. The advertisement associator 126 responds to the control signal by operating the digital ad distributor 110, video streaming service 112 and web server 114 for select advertisements for placement on web pages served by the web server 114 to the laptop 118 and smart phone 116, or advertisements to insert into digital content that is streamed to the personal computing device 120 by the video streaming service 112.

In block 202, routine 200 transforms location records and demographic records into a viewing probability metric.

In block 204, routine 200 transforms receipt record from point of sale from vendor location over time into a rating value.

In block 206, routine 200 transforms a rating value and viewing probability metric into a controller signal for an advertisement allocator.

In done block 208, routine 200 ends.

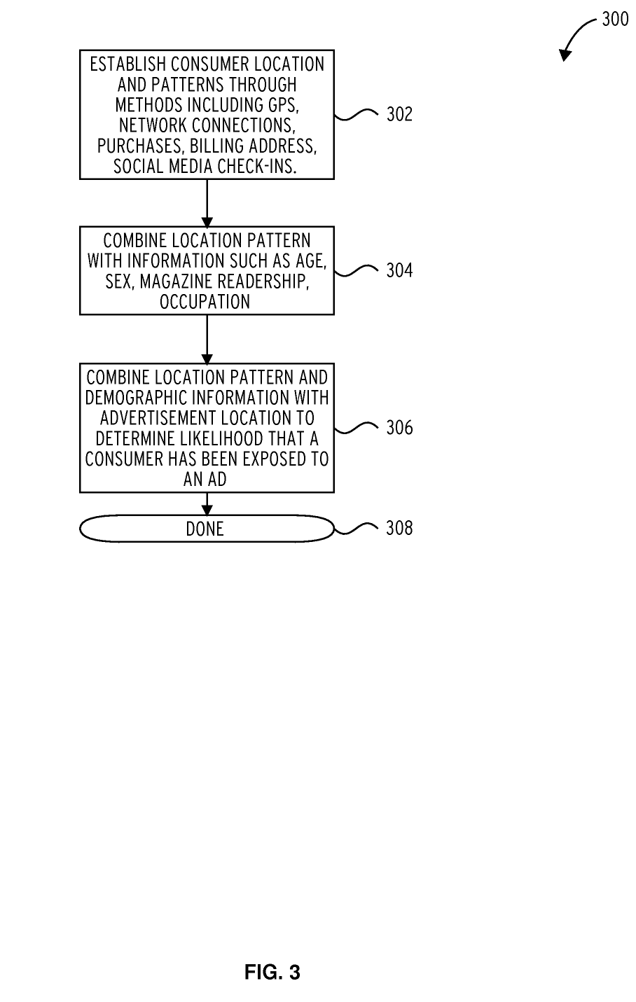

FIG. 3 is a flow chart illustrating an embodiment of an ad exposure probability determination process 300.

In block 302, the ad exposure probability determination process 300 establishes consumer locations and travel patterns through means such as GPS, network connections, purchase locations, billing address and social media.

In block 304 consumer location patterns are combined with information such as age, sex, magazine readership and occupation.

In block 306, consumer location patterns and demographic information are combined with the location of specified advertisements to determine the likelihood that a consumer has been exposed to a given advertisement.

In block 402, consumer receipt data is logged.

In block 404, products or services of interest to advertisers are logged.

In block 406 consumer receipt data is compared against list of advertiser products to determine whether any of the products on the list were purchased.

In block 408, a value is assigned if a specified product was purchased.

In block 502, a rating value is combined with a probability metric to create an indicator of how purchases relate to advertisement views.

In block 504, an indicator is compared with a success metric to determine how successful an advertisement is in prompting conversion behavior, this can be used to modify advertising campaigns and control media purchases and selection.

Input devices 604 comprise transducers that convert physical phenomenon into machine internal signals, typically electrical, optical or magnetic signals. Signals may also be wireless in the form of electromagnetic radiation in the radio frequency (RF) range but also potentially in the infrared or optical range. Examples of input devices 604 are keyboards which respond to touch or physical pressure from an object or proximity of an object to a surface, mice which respond to motion through space or across a plane, microphones which convert vibrations in the medium (typically air) into device signals, scanners which convert optical patterns on two or three dimensional objects into device signals. The signals from the input devices 604 are provided via various machine signal conductors (e.g., busses or network interfaces) and circuits to memory 606.

The memory 606 is typically what is known as a first or second level memory device, providing for storage (via configuration of matter or states of matter) of signals received from the input devices 604, instructions and information for controlling operation of the CPU 602, and signals from storage devices 610.

Information stored in the memory 606 is typically directly accessible to the CPU 602 of the device. Signals input to the device cause the reconfiguration of the internal material/energy state of the memory 606, creating in essence a new machine configuration, influencing the behavior of the digital apparatus 600 by affecting the behavior of the CPU 602 with control signals (instructions) and data provided in conjunction with the control signals.

Second or third level storage devices 610 may provide a slower but higher capacity machine memory capability. Examples of storage devices 610 are hard disks, optical disks, large capacity flash memories or other non-volatile memory technologies, and magnetic memories.

The CPU 602 may cause the configuration of the memory 606 to be altered by signals in storage devices 610. In other words, the CPU 602 may cause data and instructions to be read from storage devices 610 in the memory 606 from which may then influence the operations of CPU 602 as instructions and data signals, and from which it may also be provided to the output devices 608. The CPU 602 may alter the content of the memory 606 by signaling to a machine interface of memory 606 to alter the internal configuration, and then converted signals to the storage devices 610 to alter its material internal configuration. In other words, data and instructions may be backed up from memory 606, which is often volatile, to storage devices 610, which are often non-volatile.

Output devices 608 are transducers which convert signals received from the memory 606 into physical phenomenon such as vibrations in the air, or patterns of light on a machine display, or vibrations (i.e., haptic devices) or patterns of ink or other materials (i.e., printers and 3-D printers).

The network interface 612 receives signals from the memory 606 and converts them into electrical, optical, or wireless signals to other machines, typically via a machine network. The network interface 612 also receives signals from the machine network and converts them into electrical, optical, or wireless signals to the memory 606.

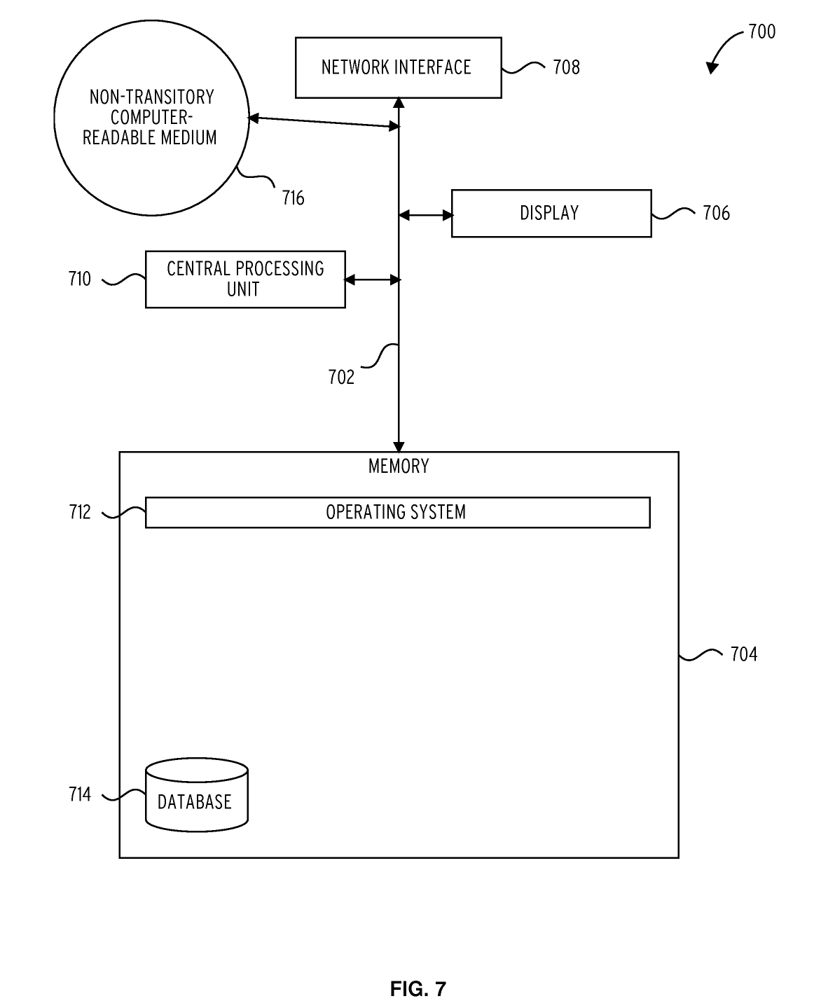

FIG. 7 illustrates several components of an exemplary server 700 in accordance with one embodiment. In various embodiments, server 700 may include a desktop PC, server, workstation, mobile phone, laptop, tablet, set-top box, appliance, or other computing device that is capable of performing operations such as those described herein. In some embodiments, server 700 may include many more components than those shown in FIG. 7. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, server 700 may comprise one or more physical and/or logical devices that collectively provide the functionalities described herein. In some embodiments, server 700 may comprise one or more replicated and/or distributed physical or logical devices.

In some embodiments, server 700 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

Server 700 includes a bus 702 interconnecting several components including a network interface 708, a display 706, a central processing unit 710, and a memory 704.

Memory 704 generally comprises a random access memory (“RAM”) and permanent non-transitory mass storage device, such as a hard disk drive or solid-state drive. Memory 704 stores an operating system 712.

These and other software components may be loaded into memory 704 of server 700 using a drive mechanism (not shown) associated with a non-transitory computer-readable medium 716, such as a floppy disc, tape, DVD/CD-ROM drive, memory card, or the like.

Memory 704 also includes database 714. In some embodiments, server 200 (deleted) may communicate with database 714 via network interface 708, a storage area network (“SAN”), a high-speed serial bus, and/or via the other suitable communication technology.

In some embodiments, database 714 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other.

“Logic” refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein.

The techniques and procedures described herein may be implemented via logic distributed in one or more computing devices. The particular distribution and choice of logic will vary according to implementation.

Those having skill in the art will appreciate that there are various logic implementations by which processes and/or systems described herein can be effected (e.g., hardware, software, and/or firmware), and that the preferred vehicle will vary with the context in which the processes are deployed. “Software” refers to logic that may be readily readapted to different purposes (e.g. read/write volatile or nonvolatile memory or media). “Firmware” refers to logic embodied as read-only memories and/or media. Hardware refers to logic embodied as analog and/or digital circuits. If an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

In a general sense, those skilled in the art will recognize that the various aspects described herein which can be implemented, individually and/or collectively, by a wide range of hardware, software, firmware, or any combination thereof can be viewed as being composed of various types of “circuitry.” Consequently, as used herein “circuitry” includes, but is not limited to, electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), circuitry forming a memory device (e.g., forms of random access memory), and/or circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

What is claimed is:

1. A system comprising:
a rating engine to transform receipt record into a rating value;
a probability engine to transform location records and demographic records into a viewing probability metric; and
a controller to transform said rating value and said viewing probability metric into a controller signal.

2. The system of claim 1, wherein the rating engine comprises logic to receive said receipt record from physical and electronic receipts.

3. The system of claim 1, wherein the rating engine comprises logic to receive said receipt record from a user interface.

4. The system of claim 1, wherein the rating engine comprises logic to receive said receipt record from an external software application.

5. The system of claim 1, wherein said receipt record comprises transaction records.

6. The system of claim 1, wherein said probability engine comprises logic to receive said location records and said demographic records from a user interface.

7. The system of claim 1, wherein the controller comprises logic to receive said rating value from said rating engine, logic to receive said viewing probability metric from said probability engine and logic to transmit said controller signal.

8. A method for controlling advertisement allocation comprising:
transforming location records and demographic records into a viewing probability metric;
transforming receipt record from point of sale from vendor location over time into a rating value; and
transforming said rating value and said viewing probability metric into a controller signal for an advertisement allocator.

9. The method of claim 8 wherein said receipt record from point of sale further comprises information from physical receipts.

10. The method of claim 8 wherein said receipt record from point of sale further comprises information from electronic receipts.

11. A computing apparatus for controlling an advertisement allocator, the computing apparatus comprising:
a processor;
a memory storing instructions that, when executed by the processor, configure the apparatus to:
transform location records and demographic records into a viewing probability metric;
transform receipt record from point of sale from vendor location over time into a rating value; and
transform said rating value and said viewing probability metric into a controller signal for an advertisement allocator.
